(19) United States
(12) Patent Application Publication
(10) Pub. No.: US 2023/0179966 A1
(43) Pub. Date: Jun. 8, 2023

(54) SMISHING FRAUD PREVENTION SYSTEM, METHOD AND PROGRAM

(71) Applicant: Nippon Telegraph and Telephone Corporation, Tokyo (JP)

(72) Inventors: Ruriko MATSUURA, Musashino-shi, Tokyo (JP); Shuji KIMURA, Musashino-shi, Tokyo (JP); Taichi OSADA, Musashino-shi, Tokyo (JP); Nobuhiro KIMURA, Musashino-shi, Tokyo (JP); Takashi YASUNAGA, Musashino-shi, Tokyo (JP); Masahiko NOGUCHI, Musashino-shi, Tokyo (JP); Ryo NAGAOKA, Musashino-shi, Tokyo (JP); Takato TODA, Musashino-shi, Tokyo (JP)

(21) Appl. No.: 18/013,994

(22) PCT Filed: Jul. 2, 2020
(86) PCT No.: PCT/JP2020/026032

§ 371 Date: Dec. 30, 2022

(51) Int. Cl. H04W 4/18; H04L 51/212; H04W 12/128

(52) U.S. Cl. CPC H04W 4/18; H04L 51/212; H04W 12/128

(57) ABSTRACT

A smishing prevention system includes a reception unit that receives an SMS message, a determination unit that determines whether or not a source phone number of the SMS message is a phone number registered in a company information database, a registration unit that registers a determination result in a communication history database, and a presentation unit that presents the determination result to a destination terminal of the SMS message.

### TECHNICAL FIELD

The present invention relates to a smishing prevention system, a smishing prevention method, and a smishing prevention program.

### BACKGROUND ART

In recent years, illicit money transfer damages through internet banking have been increased, and in particular, smishing for guiding to a phishing site using an SMS has been increased. As prevention of smishing, there are a technique for warning a user using an illicit phone number DB (Non Patent Literature 1), a technique for securing safety of an SMS received by a user with an SMS application (Non Patent Literature 2), a service for rejecting reception of an SMS other than phone numbers designated by a user, or the like.

### CITATION LIST

### Non Patent Literature

Non Patent Literature 1: TOBILA SYSTEMS, “‘Kantan Sumaho’ of ‘Y!mobile’ starts to standardly have the ‘spam call block’ function using a phone number database of TOBILA SYSTEMS, and the smartphone is authorized as ‘excellent spam call blocking device’”, [online], Internet <URL: https://tobila.com/news/release/p376/>

Non Patent Literature 2: engadget, “A phishing countermeasure function is added to an Android message application. To badge display on SMS from authenticated company”, [online], Internet <URL: https://japanese.engadget.com/2019/12/13/android-sms/>

### SUMMARY OF INVENTION

### Technical Problem

A user who has received an SMS cannot determine whether or not a transmission source is valid at a glance, and many messages prompt early responses (for example, message including keywords such as “abuse” or “legal procedure”). Therefore, the user accesses a URL or a phone number in the message without confirming cases of frauds on the Internet or the like and becomes a victim of a fraud. That is, as it is now, it is hard for a user side to easily determine whether or not the transmission source is valid.

Furthermore, the techniques and the service described above have problems in that the phone number is not registered the an illicit phone number DB when a damage is not confirmed, it is necessary to use a dedicated SMS application, a user can have contact with only a person who has been recognized and cannot use a service using SMS authentication, or the like.

The present invention has been made in view of the above circumstances, and an object of the present invention is to provide a smishing prevention system, a smishing prevention method, and a smishing prevention program that can easily confirm whether or not a transmission source is safe by a user who has received an SMS.

### Solution to Problem

In order to achieve the object described above, one aspect of the present invention is a smishing prevention system including a reception unit that receives an SMS message, a determination unit that determines whether or not a source phone number of the SMS message is a phone number registered in a company information database, a registration unit that registers a determination result in a communication history database, and a presentation unit that presents the determination result to a destination terminal of the SMS message.

One aspect of the present invention is a smishing prevention method performed by a smishing prevention system, including a reception step for receiving an SMS message, a determination step for determining whether or not a source phone number of the SMS message is a phone number registered in a company information database, a registration step for registering a determination result in a communication history database, and a presentation step for presenting the determination result to a destination terminal of the SMS message.

One aspect of the present invention is a smishing prevention program that causes a computer to function as the smishing prevention system.

### Advantageous Effects of Invention

According to the present invention, it is possible to provide a smishing prevention system, a smishing prevention method, and a smishing prevention program that can easily confirm whether or not a transmission source is safe by a user who has received an SMS.

### BRIEF DESCRIPTION OF DRAWINGS

FIG. 1 is a configuration diagram of a smishing prevention system according to an embodiment.

FIG. 2 is a diagram illustrating an example of a company information DB.

FIG. 3 is a diagram illustrating an example of a communication history DB.

FIG. 4 is a flowchart illustrating an operation of an SMS server.

FIG. 5 is a flowchart illustrating an operation of a WEB server.

FIG. 6 is a flowchart illustrating an operation of an SMS server according to a modification.

FIG. 7 is a hardware configuration example.

### DESCRIPTION OF EMBODIMENTS

Hereinafter, an embodiment of the present invention will be described with reference to the drawings.

### Configuration of Smishing Prevention System

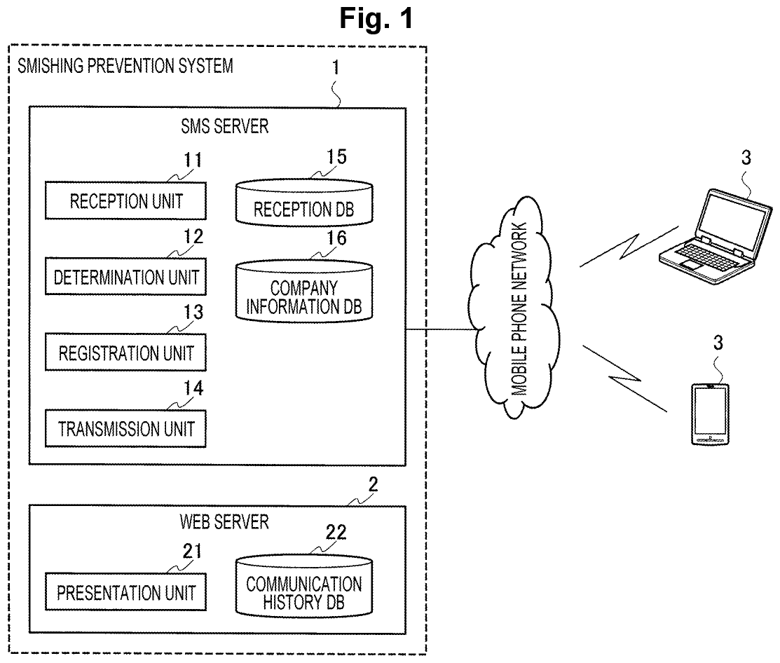

FIG. 1 is a configuration diagram illustrating a configuration of a smishing prevention system according to the present embodiment. The illustrated smishing prevention system includes an SMS server 1 and a Web server 2. The SMS server 1 and the Web server 2 are servers that are operated and managed by a communication carrier (carrier) that provides a communication service for mobile phones. Note that, in FIG. 1, the SMS server 1 and the Web server 2 are different servers. However, a single server (smishing prevention server) in which these servers are integrated may include functions of the SMS server 1 and the Web server 2.

The SMS server 1 is a server that provides a short message service (SMS). The SMS server 1 transmits a message (hereinafter, “SMS message”) of a short message service (SMS) transmitted from a terminal 3 that has a telephone function such as a smartphone or a personal computer to a destination terminal 3. The illustrated SMS server 1 includes a reception unit 11, a determination unit 12, a registration unit 13, a transmission unit 14, a reception database (DB) 15, and a company information database (DB) 16.

The reception unit 11 receives an SMS message and stores the message in the reception DB 15. The determination unit 12 determines whether or not a source phone number of the received SMS message is a phone number registered in the company information DB 16.

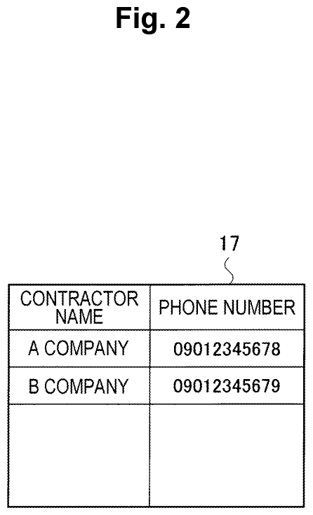

FIG. 2 is a diagram illustrating an example of the company information DB 16. In the company information DB 16, a phone number used as a source phone number when a company transmits an SMS message is registered. The illustrated company information DB 16 includes a contractor name (company name) and a phone number for each company.

The registration unit 13 registers the determination result of the determination unit 12 in a communication history database (communication history DB) 22 of the WEB server 2. In the present embodiment, the registration unit 13 registers the determination result, a reception time of the SMS message, the source phone number, and a destination phone number in the communication history DB 22. The transmission unit 14 transmits the SMS message received by the reception unit 11 to the terminal 3 having the destination phone number.

The WEB server 2 is a server that provides various types of information to a user. The WEB server 2 according to the present embodiment includes a presentation unit 21 and the communication history DB 22. The presentation unit 21 presents the determination result by the determination unit 12 of the SMS server 1 to the terminal 3 that is the destination of the SMS message. Specifically, the presentation unit 21 transmits a reception history of the SMS message to the terminal 3 registered in the communication history DB 22 to the terminal 3 in response to a request from the terminal 3.

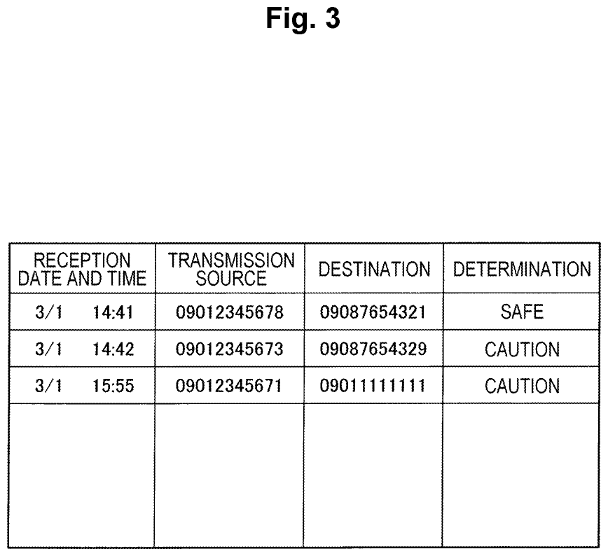

FIG. 3 is a diagram illustrating an example of the communication history DB 22. The communication history DB 22 stores a communication history of the SMS messages transmitted and received by the SMS server 1. The illustrated communication history DB 22 includes a reception date and time, a source phone number, a destination phone number, and a determination result for each SMS message. The determination result indicates whether or not the source phone number of the SMS message received by the SMS server 1 is the phone number registered in the company information DB 16. In the present embodiment, in a case where the source phone number is the phone number registered in the company information DB 16, “safe” is set, and in a case where the source phone number is a phone number that is not registered in the company information DB 16, “caution” is set.

### Operation of Smishing Prevention System

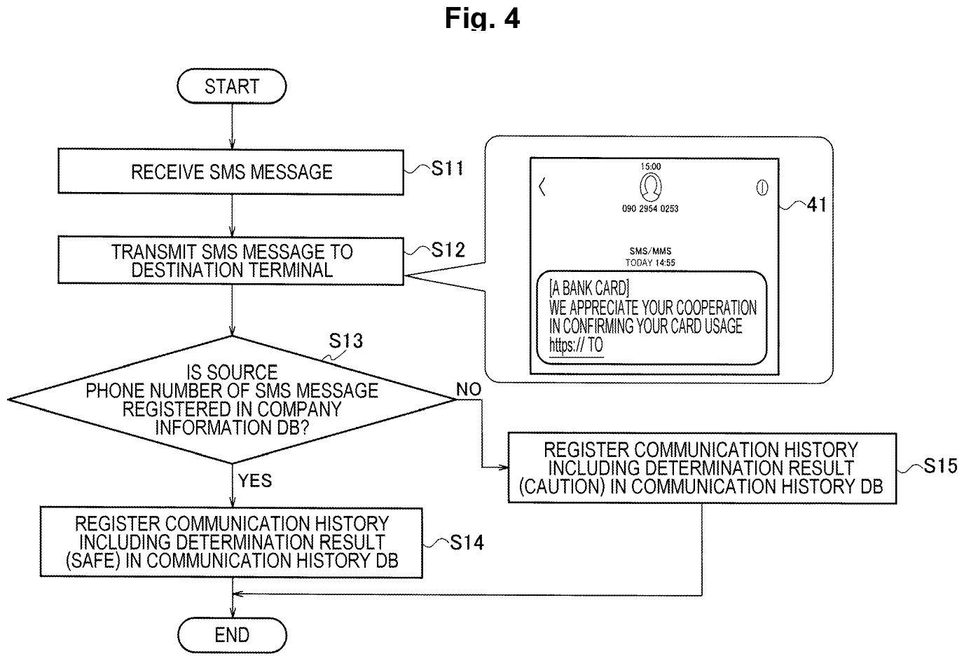

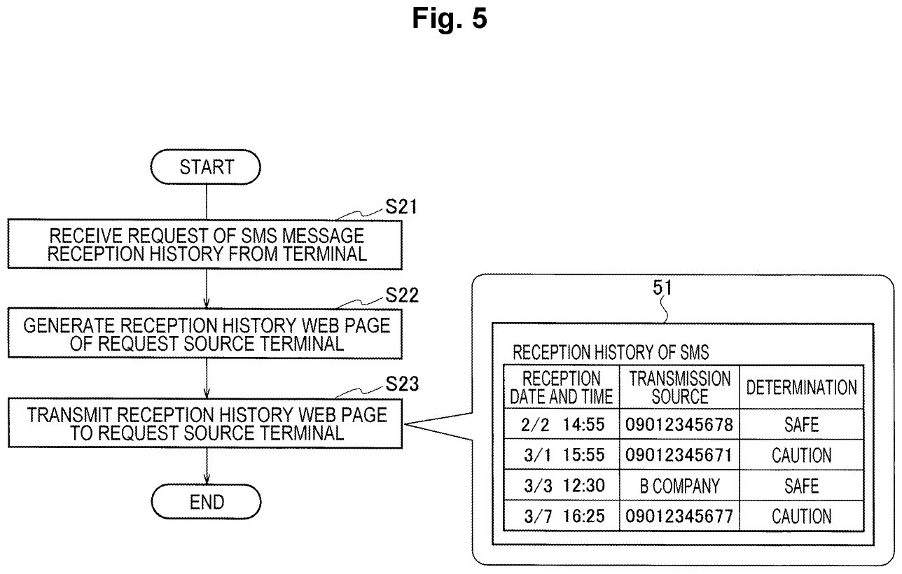

FIGS. 4 and 5 are flowcharts illustrating an operation of the smishing prevention system according to the present embodiment.

FIG. 4 is a flowchart illustrating an operation of the SMS server 1. The reception unit 11 of the SMS server 1 receives an SMS message and stores the message in the reception DB 15 (step S11). The transmission unit 14 transmits the received SMS message to the terminal 3 having a destination phone number set to the SMS message (step S12). As a result, the destination terminal 3 displays, for example, an SMS message 41 as illustrated.

Then, the determination unit 12 determines whether or not a source phone number of the SMS message received in S11 is a phone number registered in the company information DB 16 (step S13). That is, the determination unit 12 determines whether or not the SMS message is a safe SMS message transmitted from a trusted company registered in the company information DB 16.

In a case where the phone number is the phone number registered in the company information DB 16 (step S13: YES), the registration unit 13 registers a communication history including “safe” as a determination result in the communication history DB 22 (step S14). The communication history includes a reception date and time, a source phone number, and a destination phone number of the SMS message received in step S11 in addition to the determination result “safe”.

In a case where the source phone number is a phone number that is not registered in the company information DB 16 (step S13: NO), the registration unit 13 registers a communication history including “caution” as a determination result in the communication history DB 22 (step S15). The communication history includes a reception date and time, a source phone number, and a destination phone number of the SMS message received in step S11 in addition to the determination result “caution”.

Note that the operation of the SMS server 1 is not limited to be performed in the order of the flowchart illustrated in FIG. 4. For example, the transmission of the SMS message in step S12 may be performed after step S14 or S15.

FIG. 5 is a flowchart illustrating an operation of the WEB server 2. After the determination in the SMS server 1, a user of the terminal 3 that has received the SMS message accesses the WEB server 2 and confirms whether or not the received SMS message is safe.

Specifically, the user who has received the SMS message accesses an official site provided by the WEB server 2 using the terminal 3 and requests a reception history of the SMS messages. The presentation unit 21 of the WEB server 2 receives the request from the terminal 3 (step S21). The presentation unit 21 extracts a communication history in which a phone number of the request source terminal 3 is set to the destination phone number of the communication history DB 22 and generates a reception history WEB page 51 (step S22). The presentation unit 21 transmits the generated reception history WEB page 51 to the request source terminal 3 (step S23). The request source terminal 3 displays the reception history WEB page 51.

To the illustrated reception history WEB page 51, the reception date and time, the transmission source phone number (or company name embedded in phone number), and the determination result (“safe” or “caution”) determined by the SMS server 1 are set for each SMS message. As a result, the user can easily confirm whether the received SMS message is safe or needs caution.

### Modification

In the present modification, when receiving an SMS message, an SMS server 1 transmits the SMS message to a destination terminal 3 and transmits an SMS message for notification including a determination result by a determination unit 12 to the destination terminal 3. Specifically, as a method for presenting the determination result to a user, the SMS server 1 according to this modification generates the SMS message for notification including the determination result of the received SMS message and transmits the generated message to the destination terminal 3 of the received SMS message. A configuration of the smishing prevention system according to this modification is similar to that in FIG. 1.

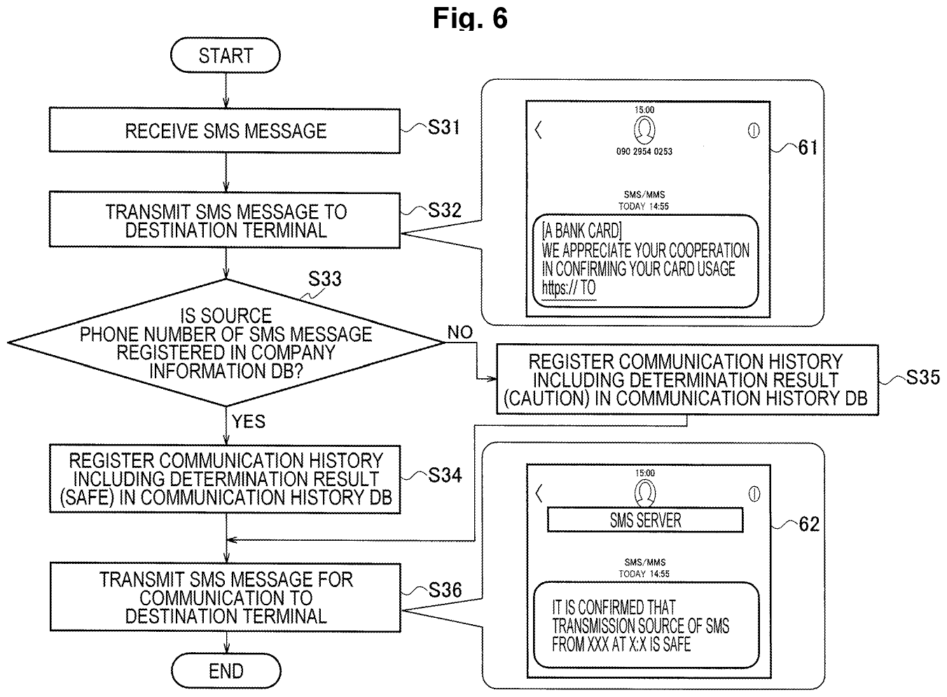

FIG. 6 is a flowchart illustrating an operation of the SMS server 1 according to the modification of the embodiment described above. Since steps S31 to S35 in FIG. 6 are respectively the same as steps S11 to S15 in FIG. 4, description will be omitted here. In step S36, the determination unit 12 generates an SMS message for notification 62 including the determination result of the SMS message received in S31 and transmits the SMS message for notification 62 to the destination terminal 3 of the SMS message.

As a result, the destination terminal 3 displays, for example, the SMS message for notification 62 as illustrated. To the SMS message for notification 62, a reception date and time, a determination result (“safe” or “caution”) determined by the determination unit 12, and a transmission source (SMS server 1) are set.

In this way, when transmitting one SMS message to the terminal 3, the SMS server 1 according to this modification transmits a second SMS message for notification that notifies the determination result of the SMS message to the terminal 3. As a result, the user can easily confirm whether the received SMS message is safe or needs caution.

Note that the operation of the SMS server 1 is not limited to be performed in the order of the flowchart illustrated in FIG. 6. For example, the transmission of the SMS message in step S32 may be performed after step S34 or S35.

In this modification, the user may request the reception history WEB page 51 in the above embodiment described with reference to FIG. 5. Alternatively, in this modification, because the SMS message for notification is transmitted to the terminal 3, it is not necessary to execute processing for transmitting the reception history WEB page 51 in FIG. 5. In this case, the smishing prevention system according to this modification includes only the SMS server 1, and the SMS server 1 does not need to include the registration unit 13.

Furthermore, as another modification of the present embodiment, an official application of a communication carrier of mobile phones (application installed at the time of purchase of smartphone) may notify the terminal 3 that has received the SMS message of the determination result determined by the determination unit 12 of the SMS server 1.

### Effects of Embodiment and Modification

The smishing prevention system according to the embodiment described above includes the reception unit 11 that receives an SMS message, the determination unit 12 that determines whether or not a source phone number of the SMS message is a phone number registered in the company information DB 16, the registration unit 13 that registers the determination result in the communication history DB 22, and the presentation unit 21 that presents the determination result to the destination terminal 3 of the SMS message. Furthermore, the determination unit 12 according to the modification generates an SMS message for notification including a determination result and transmits the message to the terminal 3.

In this way, the embodiment and the modification collates the company information DB 16 with the source phone number of the SMS message in the SMS server 1, determine whether or not the source phone number is registered in the company information DB 16, and present the determination result to a user or notify the user of the determination result. That is, since a whitelist method is used, damages can be prevented in advance. Furthermore, because the SMS server 1 makes determination, the user does not need to install a dedicated SMS application to the terminal 3, and anyone can use the determination result of the SMS message. Furthermore, when a service using SMS authentication from a valid company is used, the user can receive the SMS message with security since reliability of a transmission source can be secured by acquiring the determination result.

### Hardware Configuration

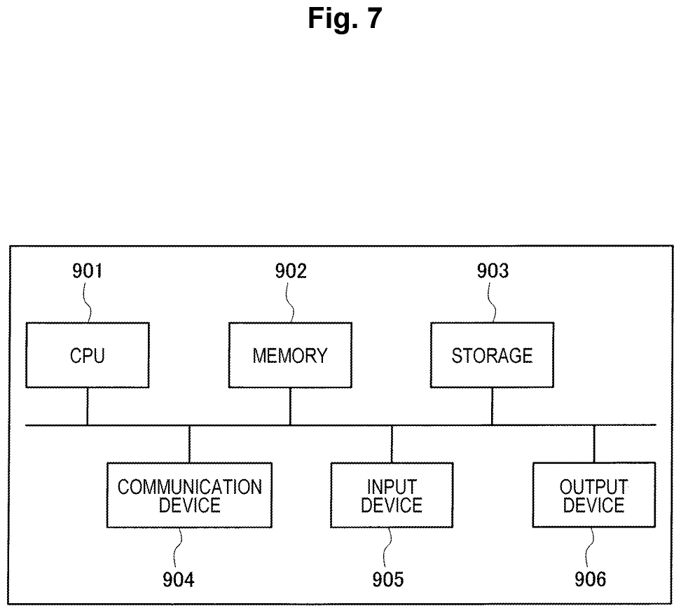

For the SMS server 1 and the WEB server 2 described above, for example, a general-purpose computer system as illustrated in FIG. 7 can be used. The illustrated computer system includes a central processing unit (CPU, processor) 901, a memory 902, a storage 903 (hard disk drive (HDD), solid state drive (SSD)), a communication device 904, an input device 905, and an output device 906. The memory 902 and the storage 903 are storage devices. In the computer system, by executing a predetermined program loaded on the memory 902 by the CPU 901, each function of each device is implemented. For example, the functions of the SMS server 1 and the WEB server 2 are implemented by respectively executing a program for the SMS server 1 by the CPU of the SMS server 1 and executing a program for the WEB server 2 by the CPU of the WEB server 2.

Furthermore, the SMS server 1 and the WEB server 2 may be implemented by a single computer or may be implemented by a plurality of computers. Furthermore, the SMS server 1 and the WEB server 2 may be virtual machines mounted on a computer.

The program for the SMS server 1 and the program for the WEB server 2 can be stored in a computer-readable recording medium such as an HDD, SSD, universal serial bus (USB) memory, compact disc (CD), or digital versatile disc (DVD) or can be distributed via a network.

Note that the present invention is not limited to the embodiment and the modification, and various modifications can be made within the scope of the gist of the present invention.

### REFERENCE SIGNS LIST

1 SMS server
11 reception unit
12 determination unit
13 registration unit
14 transmission unit
2 WEB server
21 presentation unit
22 communication history DB
3 terminal

1. A smishing prevention system comprising:
a receiver configured to receive a short message service (SMS) message;
a determination unit, implemented using one or more computing devices, configured to determine whether or not a source phone number of the SMS message is a phone number registered in a company information database;
a registration unit, implemented using one or more computing devices, configured to register a determination result in a communication history database; and
a presentation unit, implemented using one or more computing devices, configured to present the determination result to a destination terminal of the SMS message.

2. The smishing prevention system according to claim 1, wherein the presentation unit is configured to, in response to a request from the destination terminal, transmit a reception history of the SMS message to the destination terminal, the reception history registered in the communication history database.

3. The smishing prevention system according to claim 1, wherein the determination unit generates an SMS message for notification including the determination result and transmits the generated SMS message to the destination terminal.

4. A smishing prevention method performed by a smishing prevention system, comprising:
a short message service (SMS) message;
determining whether or not a source phone number of the SMS message is a phone number registered in a company information database;
registering a determination result in a communication history database; and
presenting the determination result to a destination terminal of the SMS message.

5. A non-transitory computer recording medium storing a smishing prevention program, wherein execution of the smishing prevention program causes one or more computers to perform operations comprising:
receiving a short message service (SMS) message;
determining whether or not a source phone number of the SMS message is a phone number registered in a company information database;
registering a determination result in a communication history database; and
presenting the determination result to a destination terminal of the SMS message.

6. The non-transitory computer recording medium according to claim 5, wherein the operations further comprise transmitting, in response to a request from the destination terminal, a reception history of the SMS message to the destination terminal, the reception history registered in the communication history database.

7. The non-transitory computer recording medium according to claim 5, wherein the operations further comprise generating an SMS message for notification including the determination result and transmits the generated SMS message to the destination terminal.
